(19) United States
(12) Patent Application Publication
(10) Pub. No.: US 2025/0334769 A1
(43) Pub. Date: Oct. 30, 2025

(54) OPTICAL FEEDTHROUGH DEVICE

(71) Applicant: Molex, LLC, Lisle, IL (US)

(72) Inventors: Hui-Chin Yang, Taipei (TW); Tung-Min Chen, Taipei (TW); Cheng-Wei Hsu, Taipei (TW); Wenzong Chen, Naperville, IL (US); Joshua John Krantz, Wheaton, IL (US)

(21) Appl. No.: 19/194,066

(22) Filed: Apr. 30, 2025

Related U.S. Application Data
(60) Provisional application No. 63/678,560, filed on Aug. 2, 2024.

(30) Foreign Application Priority Data
Apr. 30, 2024 (CN) 202410540900.9
Jan. 9, 2025 (CN) 202510037144.2

(51) Int. Cl. G02B 6/44

(52) U.S. Cl. CPC G02B 6/44775

(57) ABSTRACT

Feedthrough devices are described. An example optical feedthrough device includes a housing assembly with a front housing frame, a rear housing unit, and an optical signal module. The optical signal module includes a fiber optic cable bundle, a sealing block, and a cable boot positioned along a length of the cable bundle. The cable is seated into the sealing block, such as within an open slot or groove formed in the sealing block. The front housing frame includes an open flange end and a sealing wall end. The sealing wall end includes a through hole, and the sealing block of the optical signal module is positioned within the through hole to form a seal. The seal can be a fluid-tight seal, such as a hermetic seal from gases, liquids, and related fluids. The feedthrough device can be installed as part of an immersion cooling system as an example application.

### BACKGROUND

The amount of data processed by computing, network switching, telecommunications, and related systems continues to increase. Data centers can include hundreds or thousands of networking and computing systems. The systems are interconnected by optical cables, copper cables, and various connectors, adapters, and terminations between them. The data throughput of the interconnection systems is high and increasing. A range of different input/output (I/O) connectors, cables, cable assemblies, and interconnect systems are designed for those types of data, power, and data and power interconnection applications.

Example interconnect systems include board-to-board, cable-to-cable, wire-to-wire, and cable- or wire-to-board systems. A variety of designs exist for each type of connector, cable assembly, and interconnect system, depending on the requirements of the power and data communications environment in which the connectors, assemblies, and systems are used. As one example, a cable-to-cable optical connector assembly includes an optical cartridge attached to the free end of a fiber optic cable assembly and an optical receptacle connector attached to a bulkhead. The optical cartridge can be inserted into the optical receptacle to establish optical communications through the optical connector assembly.

### SUMMARY

Aspects of feedthrough devices are described. The feedthrough devices can be installed or used with immersion cooling and related systems, among other types of systems. An example optical feedthrough device includes a housing assembly with a front housing frame, a rear housing unit, and an optical signal module. The optical signal module includes a fiber optic cable bundle, a sealing block, and a cable boot positioned along a length of the cable bundle. The cable is seated into the sealing block, such as within an open slot or groove formed in the sealing block. The front housing frame includes an open flange end and a sealing wall region or end. The sealing wall region includes a through hole, and the sealing block of the optical signal module is positioned within the through hole to form a seal. The seal can be a fluid-tight seal, such as a hermetic seal from gases, liquids, and related fluids. The feedthrough device can be installed as part of an immersion cooling system as an example application.

Another feedthrough device includes housing assembly, a fiber optic cable bundle and a cable boot positioned along a length of the fiber optical cable bundle, and a sealing block including a groove. The housing assembly includes a through hole in a sealing wall region, the cable boot is positioned in the groove of the sealing block, and the sealing block is positioned within the through hole with the fiber optic cable bundle extending through the sealing block.

Another example feedthrough device includes a housing assembly, a fiber optic cable and a cable boot positioned along a length of the fiber optical cable, and a sealing block including a groove. The cable boot is positioned in the groove of the sealing block, and the sealing block and cable boot are positioned within a through hole in a sealing wall region of the housing assembly.

In other aspects, the optical signal modules described herein can include a plurality of fiber optic cable bundles and a cable boot positioned along a length of each fiber optic cable bundle. The sealing block includes a plurality of grooves, and each cable boot is positioned in one of the plurality of grooves. In other aspects of the embodiments, the sealing block is positioned in the through hole with a region of free space remaining at one side of the through hole, and the feedthrough device also includes a sealant positioned within the free space in the through hole. The cable boot can also be positioned in the groove of the sealing block with a region of the groove being unoccupied by the cable boot, and the sealant can be positioned within the region of the groove that is unoccupied by the cable boot.

In other aspects, a front support wall is secured within an opening in the front housing frame, a rear support wall secured at an end of the rear housing unit, a connection adapter supported in the front support wall, and an optical receptacle supported in the rear support wall. The fiber optic cable bundle extends from the connection adapter supported in the front support wall, through the sealing block and a sealing wall region of the front housing frame, and to the optical receptacle supported in the rear support wall. The front support wall can be secured against an inner flange rim surface within an opening in the front housing frame. The front support wall can include vents that permit fluids, such as liquids, gases, or both liquids and gases, to pass within an interior space of the front housing frame.

In another example, a plurality of connection adapters are supported in the front support wall, and a plurality of optical receptacles are supported in the rear support wall. The optical signal module includes a plurality of fiber optic cable bundles, and each fiber optic cable bundle among the plurality of fiber optic cable bundles extends from a respective connection adapter in the front support wall, through a sealing wall region of the front housing frame, and to a respective optical receptacle in the rear support wall.

In some embodiments the feedthrough device also includes an optical reshuffling bridge unit positioned within the rear housing unit and between the plurality of fiber optic cable bundles. The optical reshuffling bridge unit routes individual fiber optic cables among the fiber optic cable bundles between the plurality of connection adapters and the plurality of optical receptacles.

In other aspects, the housing assembly includes a front housing frame, a rear housing unit, and a housing sleeve positioned around the rear housing unit. The rear housing unit includes an upper rear housing unit and a lower rear housing unit, and the upper rear housing unit and the lower rear housing unit are hermaphroditic housing units. The upper rear housing unit and the lower rear housing unit include complimentary interlocking edges in one example.

In still other aspects, the housing sleeve includes an elongated aperture formed in a side of the housing sleeve. A threaded knob can extend through the elongated aperture and can be threaded into a threaded aperture on a side of the rear housing unit. When the threaded knob is fully threaded into the threaded aperture by rotating, the threaded knob mechanically secures the housing sleeve in place with respect to the rear housing unit. Further, in some cases, the elongated aperture includes an eyelet centrally positioned along the elongated aperture. The eyelet can be larger than a remainder of the elongated aperture. The threaded knob can include a knob head, a shaft, and a threaded portion of the shaft. The threaded portion of the shaft can fit through the eyelet of the elongated aperture with a clearance. A mechanical interference exists between the threaded portion of the shaft and the remainder of the elongated aperture, and a mechanical clearance exists between the threaded portion of the shaft and the remainder of the elongated aperture.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example feedthrough device and optical cartridges according to various embodiments of the present disclosure.

FIG. 1B illustrates another perspective view of the feedthrough device shown in FIG. 1A according to various embodiments of the present disclosure.

FIG. 2A illustrates another perspective view of the feedthrough device shown in FIG. 1A according to various embodiments of the present disclosure.

FIG. 2B illustrates a front view of the feedthrough device shown in FIG. 2A according to various embodiments of the present disclosure.

FIG. 2C illustrates a rear view of the feedthrough device shown in FIG. 2A according to various embodiments of the present disclosure.

FIG. 2D separately illustrates a rear housing of the feedthrough device shown in FIG. 2A according to various embodiments of the present disclosure.

FIG. 2E illustrates an example threaded knob used in the feedthrough device shown in FIG. 2A according to various embodiments of the present disclosure.

FIG. 3 illustrates the feedthrough device shown in FIG. 2A with parts of the rear housing unit moved to show the optical signal modules according to various embodiments of the present disclosure.

FIG. 4 illustrates the sectional view of the feedthrough device designated “A-A” in FIG. 2A according to various embodiments of the present disclosure.

FIG. 5A illustrates an optical signal module according to various embodiments of the present disclosure.

FIG. 5B illustrates another view of an optical signal module according to various embodiments of the present disclosure.

FIG. 6A illustrates a back perspective view of the front housing frame of the feedthrough device shown in FIG. 2A according to various embodiments of the present disclosure.

FIG. 6B illustrates a front view of the front housing frame shown in FIG. 6A according to various embodiments of the present disclosure.

### DETAILED DESCRIPTION

As noted above, the amount of data processed by computing, network switching, telecommunications, and related systems continues to increase. Data centers can include hundreds or thousands of networking and computing systems. The systems are interconnected by optical cables, copper cables, and various connectors, adapters, and terminations between them. The data throughput of the interconnection systems is high and increasing. A range of different input/output (I/O) connectors, cables, cable assemblies, and interconnect systems are designed for those types of data, power, and data and power interconnection applications.

Computing systems can consume a significant amount of power in some cases and may dissipate a relatively large amount of heat. Immersion cooling systems can be used to capture and remove that heat. Networking and computing systems can be immersed in a dielectric, electrically non-conductive fluid within a cooling tank of such immersion cooling systems. The fluid within the cooling tanks has a significantly higher thermal conductivity than air, and immersion cooling systems are capable of transferring heat away from computing systems faster and more effectively than forced air cooling systems. Feedthrough devices can be installed in such immersion cooling systems to facilitate the communication of data through optical cables, copper cables, and related connectors, adapters, and terminations between the computing systems immersed within the cooling tanks and other computing systems located outside of the cooling tanks.

Aspects of feedthrough devices are described. The feedthrough devices can be installed or used with immersion cooling and related systems, among other types of systems. An example optical feedthrough device includes a housing assembly with a front housing frame, a rear housing unit, and an optical signal module. The optical signal module includes a fiber optic cable bundle, a sealing block, and a cable boot positioned along a length of the cable bundle. The cable is seated into the sealing block, such as within an open slot or groove formed in the sealing block. The front housing frame includes an open flange end and a sealing wall region or end. The sealing wall region includes a through hole, and the sealing block of the optical signal module is positioned within the through hole to form a seal. The seal can be a fluid-tight seal, such as a hermetic seal from gases, liquids, and related fluids. The feedthrough device can be installed as part of an immersion cooling system as an example application.

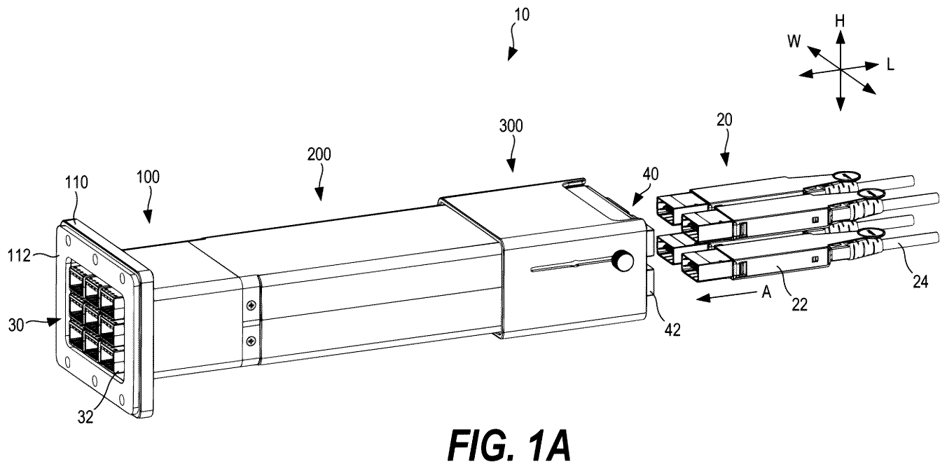

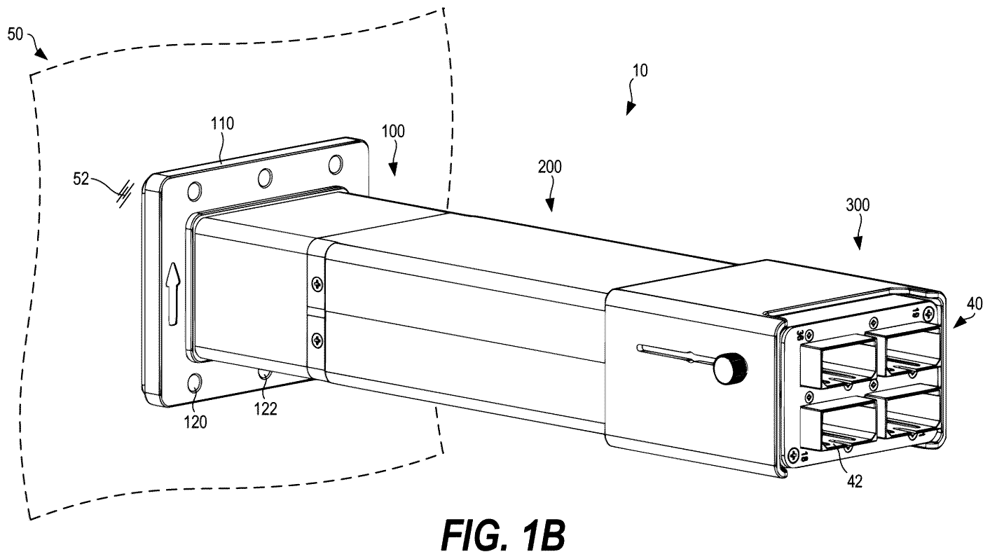

Turning to the drawings, FIG. 1A illustrates a perspective view of an example feedthrough device 10 and optical cartridges 20 according to various embodiments of the present disclosure. The feedthrough device 10 is shown to have a length, a width, and a height in the directions shown in FIG. 1A. The feedthrough device 10 is illustrated as a representative example and is not drawn to any particular scale or size, however. The shape, size, proportion, and other characteristics of the feedthrough device 10 can vary as compared to that shown. A number of feedthrough devices similar to the feedthrough device 10 can also be arranged and used together for higher data rate interconnections in some cases. One or more parts or components of the feedthrough device 10, as illustrated in the drawings and described below, can be omitted in some cases. The feedthrough device 10 can also include other parts or components that are not illustrated or described.

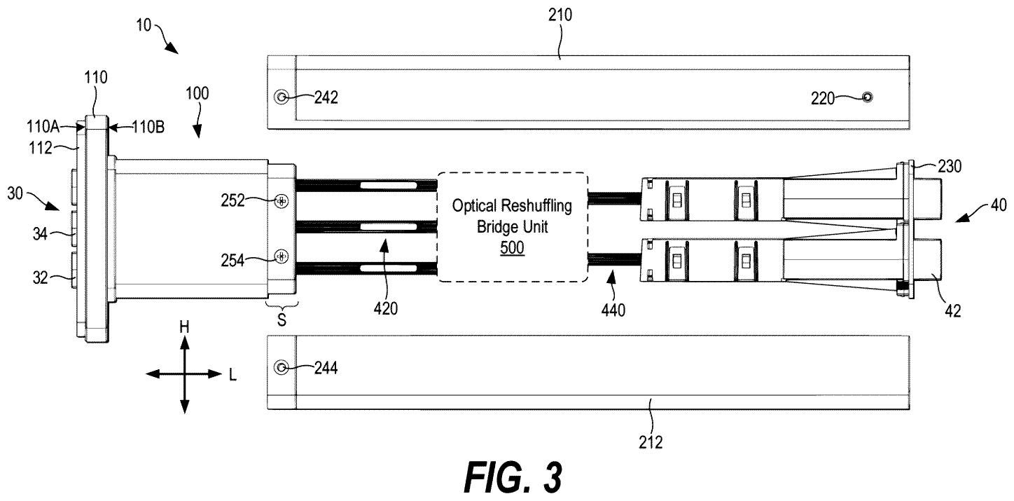

The feedthrough device 10 includes a housing assembly. The housing assembly of the feedthrough device 10 includes a front housing frame 100, a rear housing unit 200, and a housing sleeve 300. The rear housing unit 200 is secured to the front housing frame 100, and the housing sleeve 300 is secured to the rear housing unit 200 in the manner described below. The front housing frame 100 includes a flange 110 at a front open flange end. The front housing frame 100 also includes a gasket 112 positioned over the front face of the flange 110, among other features described below. The flange 110 also includes a number of through holes or apertures through the flange 110, such as the apertures 120 and 122, among others. The apertures 120 and 122 extend through the flange 110 from the front face 110A (see FIG. 3) of the flange 110 to the rear face 110B (see FIG. 3) of the flange 110. Screws, bolts, or other fasteners or fastening means can be extended through the apertures in the flange 110 to secure the feedthrough device 10 to a surface of another device or assembly, such as an immersion cooling system.

A front support wall is positioned and secured within the open end of the flange 110, and connection adapters 30 are positioned and secured within the front support wall. The connection adapter 32, for example, is secured and supported by the front support wall within the flange 110. Nine (9) connection adapters 30 are shown within the open end of the flange 110 in FIG. 1A, but the feedthrough device 10 can be designed to accommodate any number of connection adapters 32 (e.g., greater or less than nine) in other cases.

A number of optical receptacles 40 are secured and positioned within the rear housing unit 200. The optical receptacle 42 (also “receptacle 42”), for example, is secured and positioned at a far end of the rear housing unit 200. The feedthrough device 10 includes four (4) optical receptacles 40 within the rear housing unit 200, as described in further detail below, but the feedthrough device 10 can be designed to accommodate any number of optical receptacle in other cases.

FIG. 1A also depicts four (4) optical cartridges 20, including optical cartridge 22 (also “cartridge 22”), behind the feedthrough device 10. An optical cable 24 is terminated at (e.g., ends at) the cartridge 22, as with the other optical cartridges 20. The optical cartridges 20 can be inserted, in the direction “A” shown in FIG. 1A, into the optical receptacles 40 at the back of the rear housing unit 200. The cartridge 22 can be inserted into the receptacle 42, and the other optical cartridges 20 can be inserted into the other optical receptacles 40 that are secured within the feedthrough device 10.

The cartridge 22 and the receptacle 42 can include a range of different components that facilitate the optical coupling of optical signals between them, without any particular limitation. As an example, the cartridge 22 can include one or more optical ferrules, and fiber optic cables from the optical cable 24 can be optically terminated to the optical ferrules within the optical cartridge 22. Another array of one or more optical ferrules can be positioned and secured within the receptacle 42. When the cartridge 22 is inserted into the receptacle 42, the arrays of optical ferrules can be aligned to permit the transmission of light between them for optical communications between the cartridge 22 and the receptacle 42.

The feedthrough device 10 is designed to permit the feedthrough of (e.g., the passage of, extension of, etc.) fiber optic cables from the front housing frame 100 to the rear housing unit 200 with a seal or boundary positioned within the feedthrough device 10. The feedthrough device 10 is not limited to passing fiber optic cables, however, and the concepts described herein can be applied to sealing feedthroughs for copper cables, coaxial cables, twin-axial cables, and other types of cables. The seal is positioned at a sealing wall region of the front housing frame 100, as described below. A number of optical cable bundles extend within the feedthrough device 10 from the connection adapters 30 at the flange 110, through the seal, and to the optical receptacles 40 at the end of the rear housing unit 200. Thus, the feedthrough device 10 is designed to permit the communication of optical signals from the connection adapters 30 at the flange 110 to the optical receptacles 40 at the end of the rear housing unit 200 with a sealing boundary positioned within the feedthrough device 10. The seal within the feedthrough device 10 is described in further detail below. The seal can be a fluid-tight seal, such as a hermetic seal from gases, liquids, and related fluids. The seal can also prevent any solid materials from passing through the feedthrough device 10.

In some cases, the feedthrough device 10 can include an optical reshuffling bridge within the unit rear housing unit 200. The optical reshuffling bridge can route certain optical signals carried on certain optical cables among the connection adapters 30 at the flange 110 and the optical receptacles 40 at the end of the rear housing unit 200. The optical reshuffling bridge is also described in further detail below. The feedthrough device 10 can omit the optical reshuffling bridge in some cases.

The feedthrough device 10 can be installed as part of an immersion cooling system as an example application. Data centers can include hundreds or thousands of networking and computing systems. The systems are interconnected by optical cables, copper cables, and various connectors, adapters, and terminations between them. The systems consume a significant amount of power in some cases and may dissipate a relatively large amount of heat. Immersion cooling systems can be used to capture and remove that heat, when the networking and computing systems are immersed in a dielectric, electrically non-conductive fluid within a cooling tank. The fluid within the cooling tank can have a significantly higher thermal conductivity than air, and immersion cooling systems are capable of transferring heat faster and more effectively than forced air cooling systems.

The feedthrough device 10 can be installed as part of such an immersion cooling system to facilitate the communication of data to the networking and computing systems that are immersed in the fluid within the cooling tank. Particularly, the feedthrough device 10 facilitates the extension of fiber optic cables to computing systems that are immersed in cooling tanks, while avoiding any leaks (i.e., sealing against leaks) of fluid around the cables. When installed with an immersion cooling system, the connection adapters 30 can be submerged in and exposed to fluid within a cooling tank, and the optical receptacles 40 can be outside of and not exposed to the fluid.

FIG. 1B illustrates the feedthrough device 10 installed on an immersion cooling system. The immersion cooling system includes a tank wall 50 with an outer surface 52. An opening (not shown/visible) is formed through the tank wall 50. The feedthrough device 10 is installed over the opening through the tank wall 50. More particularly, the front surface of the flange 110 is positioned against the outer surface 52 of the tank wall 50, over the opening through the tank wall 50. The gasket 112 is positioned between the front face of the flange 110 and the outer surface 52 of the tank wall 50 in that arrangement, to provide a seal between them. Thus, the connection adapters 32 (see FIG. 1A) of the feedthrough device 10 are accessible through the opening in the tank wall 50.

A liquid cooling fluid is contained within the immersion cooling system, as would be understood in the field. The opening through the tank wall 50 can be positioned above, below, or at the level of the liquid cooling fluid within the immersion cooling system. In one example, the opening through the tank wall 50 is positioned above the level of the liquid cooling fluid, which is referred to as the vapor zone. Only the vapor of the liquid cooling fluid is present in the vapor zone. In that case, the feedthrough device 10 is installed above the level of the liquid cooling fluid and only vapor from the liquid cooling fluid enters the front housing frame 100 of the feedthrough device 10 and is sealed within the front housing frame 100.

The flange 110 also includes a number of through holes or apertures through the flange 110, such as the apertures 120 and 122, among others. The apertures 120 and 122 extend through the flange 110 from the front face 110A (see FIG. 3) of the flange 110 to the rear face 110B (see FIG. 3) of the flange 110. Screws, bolts, or other fasteners or fastening means can be extended through the apertures 120 and 122, among others, in the flange 110, to secure the feedthrough device 10 to the tank wall 50. The installation of the feedthrough device 10 is provided as a representative example in FIG. 1B. The feedthrough device 10 can be installed in other ways and to other systems.

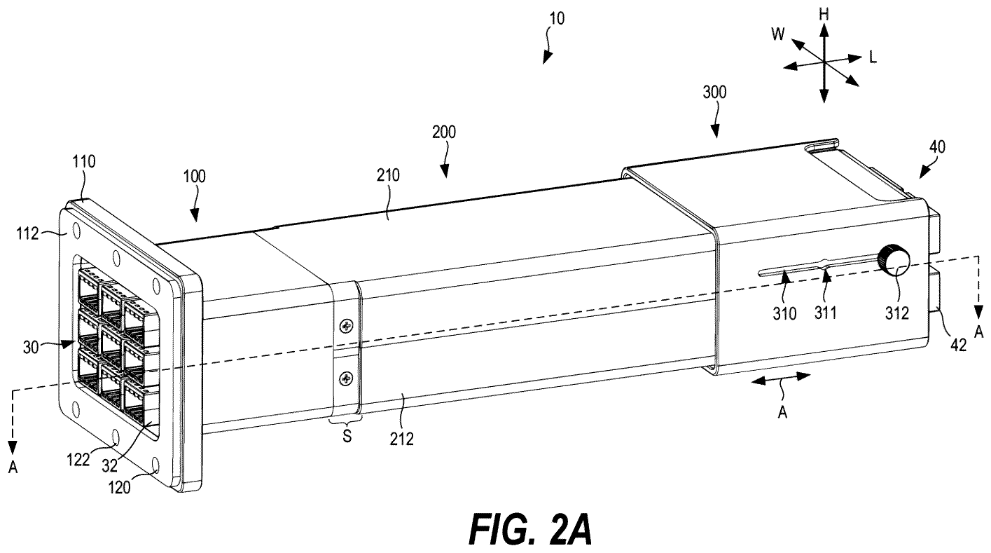

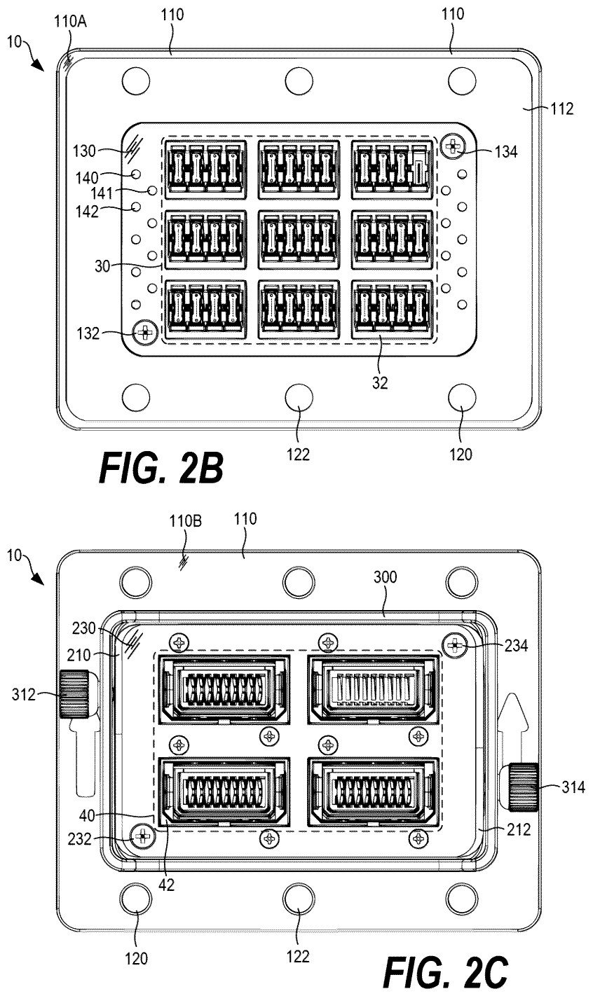

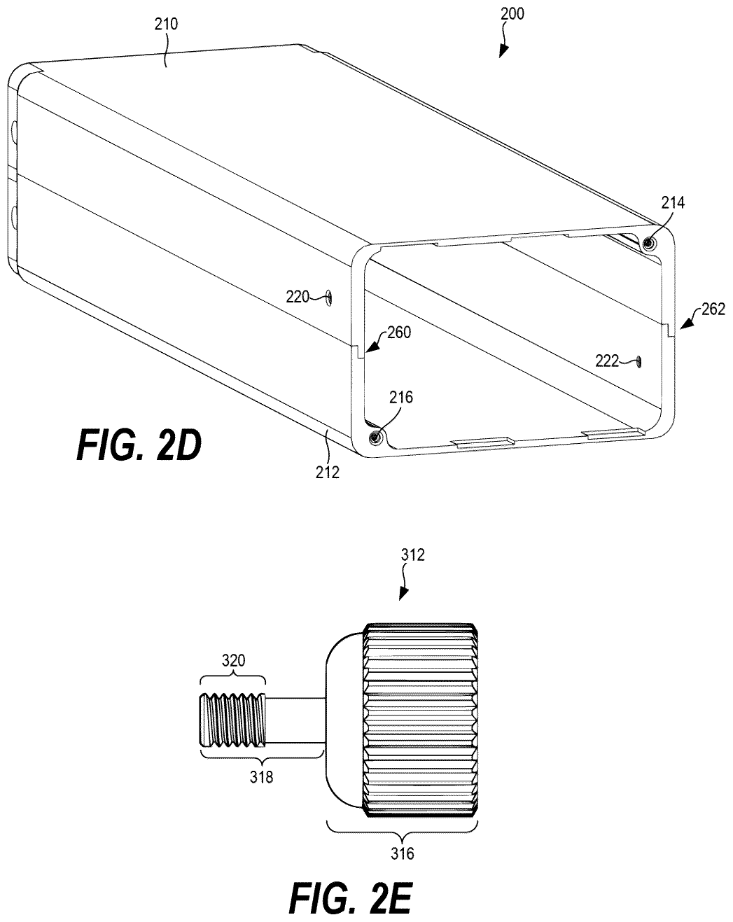

FIG. 2A illustrates another perspective view of the feedthrough device 10 shown in FIG. 1. The optical cartridges 20 are omitted from view in FIG. 2A. The front housing frame 100, rear housing unit 200, and housing sleeve 300 can be formed from a range of suitable materials. The front housing frame 100, rear housing unit 200, and housing sleeve 300 can be formed from the same materials as each other or using different materials or combinations of different materials. As one example, the front housing frame 100 can be formed from a metal, such as aluminum, or another suitable metal or metal alloy. Metals have a relatively low coefficient of thermal expansion (CTE) compared to other materials, such as plastics, which can be preferable for maintaining seals during temperature cycling. In other cases, the front housing frame 100 can be formed from a plastic, such as liquid crystal polymer (LCP), polyethylene (PE), polytetrafluoroethylene (PTFE), fluoropolymer, or other plastic or insulating material(s). Certain surfaces or surface areas of the front housing frame 100 can be plated with a plating metal or metals for conductivity, and the front housing frame 100 can be embodied as a plated plastic component in some cases. The front housing frame 100 can also be formed from combinations of insulating and conductive materials in other cases. The front housing frame 100 can be formed by any suitable additive or subtractive manufacturing techniques, such as molding, diecasting, injection molding, printing, and other techniques. The front housing frame 100 can be formed as a single integrated component or part or as two or more parts or pieces that can be assembled together in various embodiments.

The rear housing unit 200 can be formed from the same or different materials as compared to the front housing frame 100. In the example depicted in FIG. 2A, the rear housing unit 200 is formed as two parts, including an upper rear housing unit 210 and a lower rear housing unit 212. The upper rear housing unit 210 and the lower rear housing unit 212 can be the same size and shape as each other in one example, but the units 210 and 212 can also be different sizes and shapes as compared to each other. Other aspects of the rear housing unit 200 are described in further detail below with reference to FIGS. 2D and 3.

The housing sleeve 300 can also be formed from the same or different materials as compared to the front housing frame 100 and the rear housing unit 200. The housing sleeve 300 is formed as a sleeve and is positioned around and over the rear housing unit 200. The housing sleeve 300 includes an elongated aperture 310 formed in one side. Although not visible in FIG. 2A, the housing sleeve 300 also includes another elongated aperture similar to the elongated aperture 310, and it is formed in the opposite side of the housing sleeve 300. The housing sleeve 300 surrounds (e.g., wraps around) the rear housing unit 200, over part of the length “L” of the rear housing unit 200, with a clearance between the inner surfaces of the housing sleeve 300 and the outer surfaces of the rear housing unit 200. The housing sleeve 300 can vary in size and can extend over a longer or shorter portion of the length “L” of the rear housing unit 200 in various embodiments. With the clearance between the inner surfaces of the housing sleeve 300 and the outer surfaces of the rear housing unit 200, the housing sleeve 300 can slide along the rear housing unit 200 in the direction “A,” as described below.

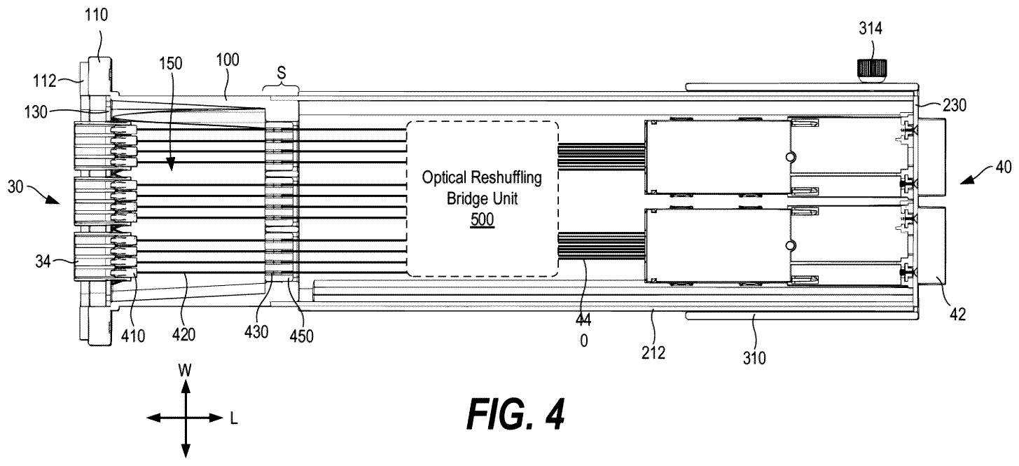

A threaded knob 312 extends through the elongated aperture 310 of the housing sleeve 300 and is threaded into a threaded aperture on one side of the rear housing unit 200. The elongated aperture 310 includes an eyelet 311, which is centrally positioned along the elongated aperture 310 in the example shown. The eyelet 311 can also be located at other positions along the elongated aperture 310 in other cases, including at either one or at both ends of the elongated aperture 310. A diameter or opening size of the eyelet 311 is relatively larger than the remainder of the elongated aperture 310 in the example depicted in FIG. 2A. The threaded knob 312 extends through the elongated aperture 310 and is threaded into a threaded aperture 220 (see FIG. 3) on one side of the upper rear housing unit 210. Another threaded knob 314 (see FIGS. 2C and 4) extends through another elongated aperture on the opposite side of the housing sleeve 300 and is threaded into another threaded aperture 222 (see FIG. 2D) on an opposite side of the rear housing unit 200.

Each of the threaded knobs 312 and 314 includes a relatively large knob head and a shaft that extends from the knob head. The heads of the threaded knobs 312 and 314 can include knurled surfaces for gripping and turning the threaded knobs 312 and 314 by hand in some cases, as also described below with reference to FIG. 2E. At least a portion of length of the shafts of the threaded knobs 312 and 314 are threaded. The shafts of the threaded knobs 312 and 314 extend through the elongated apertures of the of the housing sleeve 300 and are threaded into the threaded apertures 220 and 222 in the rear housing unit 200. When the threaded knobs 312 and 314 are fully threaded into the threaded apertures 220 and 222 by rotating the threaded knobs 312 and 314, the threaded knobs 312 and 314 mechanically contact and compress against outer surfaces of the housing sleeve 300, holding the housing sleeve 300 in place with respect to the rear housing unit. Thus, the housing sleeve 300 can be secured in place, such as in the position shown in FIG. 2A, when the threaded knobs 312 and 314 are tightened. The housing sleeve 300 provides additional structural support to the rear housing unit 200 particularly when the threaded knobs 312 and 314 are tightened.

When the threaded knobs 312 and 314 are loosened, the housing sleeve 300 can be repositioned along the length “L” of the rear housing unit 200 by sliding it in the direction “A” shown in FIG. 2A. The housing sleeve 300 is shown in the forward-most position in FIG. 2A (e.g., toward the front housing frame 100), but the housing sleeve 300 can be repositioned by sliding, so that it extends in part over the back of the housing sleeve 300, in which case it will extend around and cover the optical receptacles 40. Thus, the housing sleeve 300 is configured to be repositioned by sliding between forward and backward positions.

The feedthrough device 10 is designed to permit the feedthrough of (e.g., the passage of, extension of, etc.) fiber optical cables from the flange 110 to the end of the rear housing unit 200, as one example, with a seal or boundary positioned within the feedthrough device 10. The feedthrough device 10 is not limited to passing fiber optic cables, however, and the concepts described herein can be applied to sealing feedthroughs for copper cables, coaxial cables, twin-axial cables, and other types of cables. The seal is positioned at a sealing wall region of the front housing frame 100 in a sealing region “S” of the front housing frame 100. In one example, a number of optical cable bundles extend from the connection adapters 30 at the flange 110, through the sealing region “S,” and to the optical receptacles 40 at the end of the rear housing unit 200. The extension of the optical cable bundles within the feedthrough device 10 and aspects of the sealing region “S” are described in greater detail below with reference to FIG. 3.

FIG. 2B illustrates a front view of the feedthrough device 10 shown in FIG. 2A, and FIG. 2C illustrates a rear view of the feedthrough device 10 shown in FIG. 2A. As shown in FIG. 2A, the gasket 112 extends around the front face of the flange 110. The gasket 112 can be formed from a range of suitable materials, such as foam, rubber, silicone, cork, neoprene, PTFE, a plastic or related polymer, or another suitable material. The gasket 112 can be compressible and capable of forming a seal between a surface of another device or assembly, such as an immersion cooling system, and the front face 110A (see FIGS. 2A & 3) of the flange 110.

A number of through holes or apertures, such as the apertures 120 and 122, are formed through the flange 110. The apertures extend through the flange 110 from the front face 110A (see FIG. 3) of the flange 110 to the rear face 110B (see FIG. 3) of the flange 110. Screws, bolts, or other fasteners or fastening means can be extended through the apertures in the flange 110 to secure the feedthrough device 10 to a surface of another device or assembly, such as an immersion cooling system.

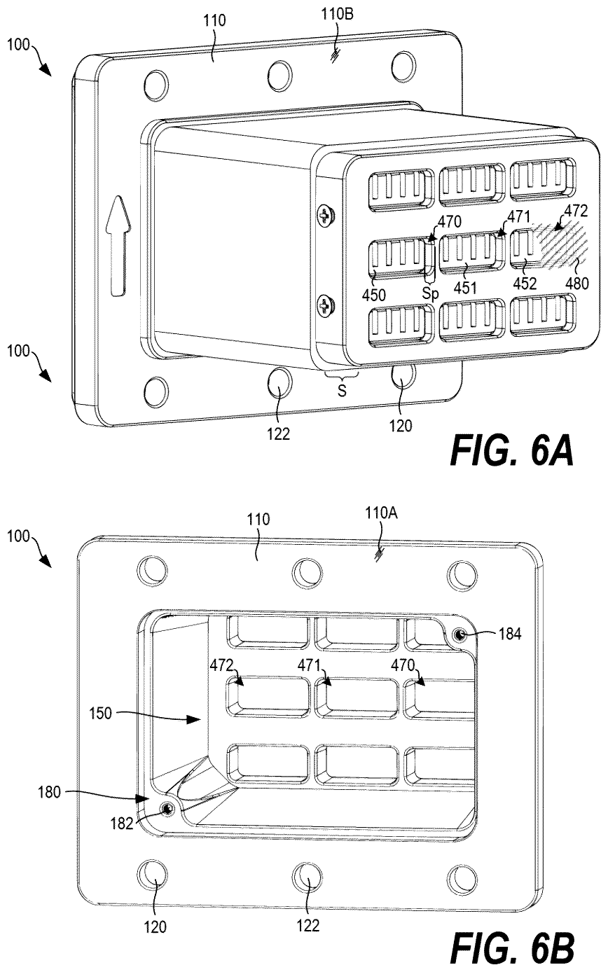

FIG. 2B also illustrates the front support wall 130 of the front housing frame 100. The front support wall 130 is positioned and secured within the open end of the flange 110, and the connection adapters 30 are positioned and secured within the front support wall 130. The front support wall 130 is seated against an inner flange rim surface within the front housing frame 100. The inner flange rim surface is described in further detail below with reference to FIG. 6B. The front support wall 130 is secured in place against the inner flange rim surface using the fasteners 132 and 134 in the example depicted in FIG. 2B.

The front support wall 130 includes vent holes, including vent holes 140-143, among others. The vent holes 140-143 permit fluid (e.g., typically gas or vapor) to pass through the front support wall 130 and into an interior space within the front housing frame 100. The fluid can pass into the interior space of the front housing frame 100 and up against the sealing region “S” (see FIGS. 2A and 4), but the fluid is sealed within the front housing frame 100 and cannot pass through the sealing region “S” of the front housing frame 100. Thus, the sealing region “S” of the front housing frame 100 prevents any fluids from passing through the front housing frame 100 to the rear housing unit 200.

The connection adapters 30 can be embodied as a type of connector or connector housing. The connection adapters 30 extend through openings in the front support wall 130 and can be secured in place using any suitable approach. The connection adapters 30 can be secured to the front support wall 130 using a friction fit, a mechanical interlocking arrangement with spring-biased interlocking fingers or tabs, mechanical fasteners, other approaches, or a combination thereof. Optical mating tips are also positioned within the connection adapters 30, as described below with reference to FIG. 4. To make a data connection, the free ends of optical cable assemblies (not shown) within a cooling tank can be inserted into the connection adapters 30 to make optical connections within the connection adapters 30. In that way, optical cable assemblies (not shown) can be connected to the connection adapters 30 at the front end of the feedthrough module 10.

FIG. 2C illustrates the rear support wall 230 of the rear housing unit 200. The rear support wall 230 is positioned and secured within a rear open end of rear housing unit 200, and the optical receptacles 40 are positioned and secured within the rear support wall 230. The rear support wall 230 is seated against supporting surface regions at the open end of the rear housing unit 200. The rear support wall 230 is secured in place using the fasteners 232 and 234 in the example depicted in FIG. 2C. The fasteners 232 and 234 are threaded into threaded apertures at one end of the rear housing unit 200, as described below with reference to FIG. 2D.

The optical receptacles 40 extend through openings in the rear support wall 230 and can be secured in place using any suitable approach. The optical receptacles 40 can be secured to the rear support wall 230 using a friction fit, a mechanical interlocking arrangement, mechanical fasteners, other approaches, or a combination thereof. As described above with reference to FIG. 1A, the optical cartridges 20 can be inserted into the optical receptacles 40. In that way, the optical cartridges 20 can be connected to the rear end of the feedthrough module 10.

FIG. 2D separately illustrates the rear housing 200 of the feedthrough device 10. The rear housing unit 200 includes the upper rear housing unit 210 and the lower rear housing unit 212. The upper rear housing unit 210 and the lower rear housing unit 212 are each formed in a type of “U” shape. The upper rear housing unit 210 and the lower rear housing unit 212 are the same size and shape in the example shown. The upper rear housing unit 210 and the lower rear housing unit 212 can be formed as a hermaphroditic (e.g., complimentary or mirror-image) pair of housing units. The upper rear housing unit 210 and the lower rear housing unit 212 each include complimentary interlocking ledges 260 and 262, which are also hermaphroditic and interlock or mate together when assembled as shown in FIG. 2D. Referring between FIGS. 2C and 2D, the fasteners 232 and 234 (see FIG. 2C) can be threaded into the threaded apertures 214 and 216 at one end of the rear housing unit 200, as shown in FIG. 2D, to secure the rear support wall 230 in place.

FIG. 2E illustrates the threaded knob 312 used in the feedthrough device 10. The threaded knob 314 can be the same as the threaded knob 312. The threaded knob 312 includes a knob head 316 and a shaft 318 that extends from the knob head 316. The knob head 316 includes knurled surfaces for gripping and turning the threaded knob 312 by hand. At least a portion of the length of the shaft 318 is threaded. In the example shown in FIG. 2C, the threaded portion 320 of the shaft 318 is threaded. The size (e.g., diameter) of the threaded portion 320 of the shaft 318 is larger than the shaft 318 itself.

When the feedthrough device 10 is assembled, the shafts of the threaded knobs 312 and 314 extend through the elongated apertures of the of the housing sleeve 300 and are threaded into the threaded apertures 220 and 222 (see FIG. 2D) in the rear housing unit 200. For example, the shaft 318 of the threaded knob 312 extends through the elongated aperture 310 of the housing sleeve 300 (see FIG. 2A) and is threaded into the threaded aperture 220 of the rear housing unit 200. The threaded portion 320 of the shaft 318 of the threaded knob 312 is larger than the remainder of the shaft 318. The threaded portion 320 fits through the central eyelet 311 of the elongated aperture 310 with a clearance. The threaded portion 320 is too large, however, to fit through the remainder of the elongated aperture 310 (i.e., other than the central eyelet 311) with a clearance. Thus, the shaft 318 of the threaded knob 312 can be inserted into the elongated aperture 310 through only the central eyelet 311, and the threaded knob 312 can be slid along the elongated aperture 310 after being inserted. A mechanical clearance exists between the shaft 318 and the elongated aperture 310. A mechanical interference between the threaded portion 320 of the shaft 318 and the elongated aperture 310 prevents the threaded knob 312 from being removed from within the elongated aperture 310, except for when positioned at the central eyelet 311. As described above, when the threaded knobs 312 and 314 are fully threaded into the threaded apertures 220 and 222 of the rear housing unit 200 by rotating, the threaded knobs 312 and 314 mechanically contact and compress against the housing sleeve 300, holding it in place.

FIG. 3 illustrates the feedthrough device 10, with the rear housing unit 200 shifted in position. The fiber optic cable bundles that extend within the rear housing unit 200 are visible in FIG. 3. The upper and lower rear housing units 210 and 212 of the rear housing unit 200 are secured to the front housing frame 100 when the feedthrough device 10 is assembled. The fasteners 252 and 254 (e.g., screws), for example, can pass through the apertures 242 and 244 of the housing units 210 and 212 and into threaded apertures in the front housing frame 100, to secure the housing units 210 and 212 in place with the front housing frame 100. The upper rear housing unit 210 and the lower rear housing unit 212 form a type of elongated tubular area behind the front housing frame 100. The optical receptacles 40 are also positioned within the elongated tubular area inside the rear housing unit 200.

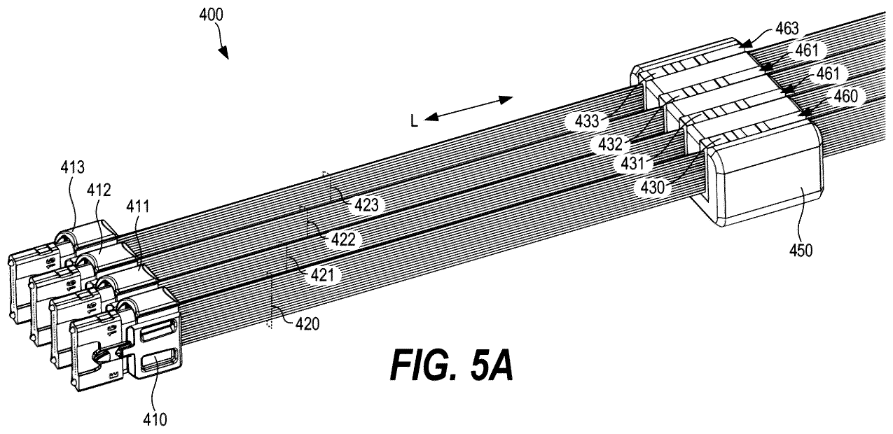

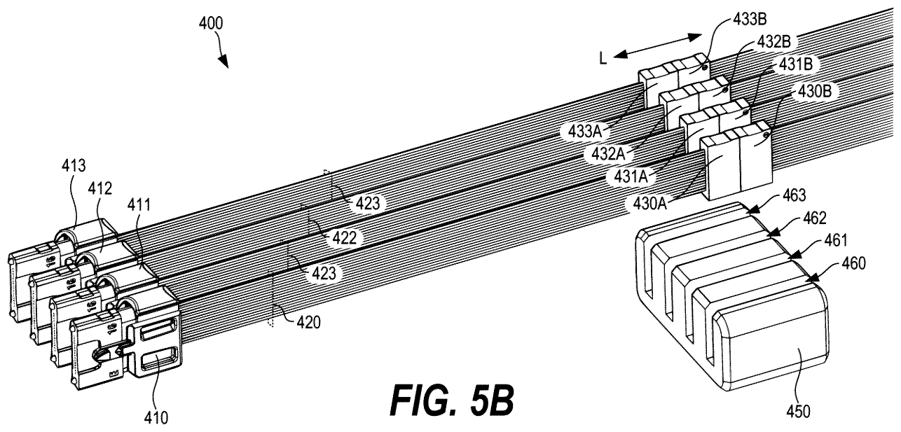

Several fiber optic cable bundles are depicted in FIG. 3, including the fiber optic cable bundle 420, the fiber optic cable bundle 440, and other cable bundles. The fiber optic cable bundles 420 and 440, among others, are parts of the optical signal modules described below with reference to FIGS. 5A and 5B. The fiber optic cable bundles 420 and 440, among others, extend from the connection adapters 30 at the flange 110, through the seal “S,” and to the optical receptacles 40 at the end of the rear housing unit 200. Each of the fiber optic cable bundles 420 and 440 includes a number of fiber optic cables arranged in a ribbon-type format in the example shown, although other types and formats of fiber optic cables and cable bundles can be relied upon. The feedthrough device 10 can accommodate any number of fiber optic cable bundles depending on the size and design of the device 10. The feedthrough device 10 is also not limited to passing fiber optic cables, however, and the concepts described herein can be applied to sealing feedthroughs for copper cables, coaxial cables, twin-axial cables, and other types of cables.

FIG. 3 also illustrates an optical reshuffling bridge unit 500. The optical reshuffling bridge unit 500 (also “reshuffling bridge 500”) can be embodied as a type of optical fiber routing assembly for individual fiber optic cables. The reshuffling bridge 500 is designed to route or reroute one or more of the individual fiber optic cables from the connection adapters 30, on one side of the reshuffling bridge 500, to one or more of the optical receptacles 40 on another side of the reshuffling bridge 500. For example, if the fiber optic cable bundle 420 includes a bundle of sixteen (16) individual fiber optic cables from the connection adapter 34, the reshuffling bridge 500 can route four (4) of those fiber optic cables to the optical receptacle 42. The reshuffling bridge 500 can also route the other fiber optic cables in the fiber optic cable bundle 420 to other optical receptacles 40 (i.e., to other than the optical receptacle 42). As other examples, the reshuffling bridge 500 can route one (1), two (2), eight (8), or more fiber optic cables from the connection adapters 30 to the optical receptacle 42, with any remaining cables being routed to other optical receptacles 40. Overall, the reshuffling bridge 500 is designed to individually route or direct fiber optic cables from certain connection adapters 30 at the flange 110 to certain optical receptacles 40 at the end of the rear housing unit 200.

The reshuffling bridge 500 can be embodied as a network of optical routes or pathways from the connection adapters 30 to the optical receptacles 40. The optical routes or pathways can be established and organized in any suitable way depending on design needs. As one example, individual, continuous (e.g., un-spliced) optical fibers extend from the connection adapters 30 to the optical receptacles 40, and the reshuffling bridge 500 is representative of the pathway taken by the optical fibers. In other cases, the reshuffling bridge 500 can be embodied as an optical switch or embodied in part as an optical switch. The reshuffling bridge 500 can also be embodied as an optical mixer or embodied in part as an optical mixer in some cases.

FIG. 4 illustrates the sectional view of the feedthrough device 10 designated “A-A” in FIG. 2A according to various embodiments of the present disclosure. FIG. 4 shows the interior space 150 within the front housing frame 100. As noted above, fluid can pass through the front support wall 130 and into the interior space 150 of the front housing frame 100. The fluid can extend up to and against the sealing region “S,” but the fluid is sealed within the front housing frame 100 and cannot pass through the sealing region “S” or into the rear housing unit 200.

FIG. 4 also illustrates how optical signal modules extend through the feedthrough device 10 from the connection adapters 30 to the optical receptacles 40. Each optical signal module includes a fiber optic cable bundle, a first plug at one distal end of the fiber optic cable bundle, and a cable boot positioned along a length of the fiber optic cable. As an example, an optical signal module in the feedthrough device 10 includes the fiber optic cable bundle 420, a plug 410 at an end of the fiber optic cable bundle 420, and a cable boot 430 positioned along a length of the fiber optic cable bundle 420. The plug 410 is positioned and secured within the connection adapter 34, along with three (3) additional plugs of other optical signal modules. Each of the fiber optic cable bundles, including the cable bundle 420, extends from a respective plug in the connection adapter 34, through the interior space 150 within the front housing frame 100, and passes through the sealing region “S” and into the rear housing unit 200.

The front housing frame 100 includes openings in the sealing region “S,” and the fiber optic cable bundles pass through the openings. However, the remaining free space between the fiber optic cable bundles and the openings in the sealing region “S” is filled and sealed closed, so that the sealing region “S” still prevents the flow of fluid through it. For example, a sealing block 450 is positioned within one of the openings in the front housing frame 100, and other sealing blocks are also positioned within other openings in the sealing region “S.” The sealing block 450 includes a number of open slots or grooves, and the cable boot 430, which is positioned along the fiber optic cable bundle 420, is secured within one of the grooves in the sealing block 450. Overall, the sealing block 450 substantially occupies and fills open space within one of the openings in the sealing region “S,” and the cable boot 430 substantially occupies and fills open space within one of the grooves in the sealing block 450. An additional sealing means, such as an epoxy or other filler, can be used to seal any remaining openings. These and other aspects are described in further detail below.

FIG. 5A illustrates an optical signal module 400 according to various embodiments of the present disclosure, and FIG. 5B illustrates another view of the optical signal module 400 shown in FIG. 5A. The feedthrough module 10 includes nine (9) optical signal modules, including the optical signal module 400 in the example depicted. Each optical signal module is terminated, at one end, at one of the connection adapters 30. Each of the optical signal module also extends through the sealing region “S,” to the bridge unit 500, and ultimately to one of the optical receptacles 40. The feedthrough module 10 can accommodate additional or fewer optical signal modules in other embodiments. The feedthrough device 10 is not limited to passing fiber optic cables, however, and the concepts described herein can be applied to sealing feedthroughs for copper cables, coaxial cables, twin-axial cables, and other types of cables.

Referring between FIGS. 5A and 5B, the optical signal module 400 includes plugs 410-413, fiber optic cable bundles 420-423, and cable boots 430-433. The plugs 410-413 are positioned, respectively, at distal ends of the fiber optic cable bundles 420-423. The cable boots 430-433 are positioned along the fiber optical cable bundles 420-423. The plugs 410-413 can be formed from LCP, PE, PTFE, fluoropolymer, or another suitable material(s). The cable boots 430-433 can be formed from an elastic and sealing material, such as a thermoplastic rubber (TPR) material. The cable boots 430-433 can also be formed from other suitable materials. The plugs 410-413 and the cable boots 430-433 can be molded around or over the fiber optic cable bundles 420-423 in one example. Alternatively, the plugs 410-413 and the cable boots 430-433 can be wrapped or placed around, slid over, or otherwise arranged over the fiber optic cable bundles 420-423. The plugs 410-413 of the optical signal module 400 are inserted into and secured with the connection adapter 34 (see FIG. 4). Plugs from other optical signal modules are, similarly, inserted into other connection adapters 30 of the feedthrough module 10.

FIGS. 5A and 5B both illustrate the sealing block 450. The sealing block 450 is separated from the cable boots 430-433 in FIG. 5B, so that the grooves 460-463 formed in the sealing block 450 are visible. The grooves 460-463 are illustrated as an example in FIGS. 5A and 5B. In other cases, the sealing block 450 can include grooves having different positions and sizes. The sealing block 450 can also include additional grooves or fewer grooves in some cases, depending on the design of the optical signal module 400.

FIG. 5B also shows that the cable boot 430 is formed of two parts or pieces, including the front cable boot 430A and the rear cable boot 430B. The cable boot 431 also includes a front cable boot 431A and the rear cable boot 431B. The cable boot 432 includes a front cable boot 432A and the rear cable boot 432B, and the cable boot 433 includes a front cable boot 433A and the rear cable boot 433B. Thus, the cable boots 430-433 can be formed in one or more parts or pieces. In some cases, where the cable boots 430-433 are formed of two or more parts or pieces, the parts can be separated from each other (i.e., with a clearance between them) when inserted into the grooves 460-463 of the sealing block 450.

The cable boots 430-433 fit respectively into the grooves 460-463 of the sealing block 450 and are seated into the grooves 460-463. Together, the cable boots 430-433 and the sealing block 450 provide part of a sealing means in the sealing region “S” of the feedthrough device 10. As described below with reference to FIGS. 6A and 6B, the front housing frame 100 includes a number of apertures or through holes 470-472 in the sealing region “S.” The cable boots 430-433 and the sealing block 450 substantially occupy and fill the open space of one of those apertures, while still permitting the fiber optic cable bundles 420-423 to pass through the opening. An additional sealing means, such as an epoxy or other filler, can be used to seal any remaining space that is not sealed by the cable boots 430-433 and the sealing block 450. To assemble the feedthrough device 10, the cable boots 430-433 can be inserted respectively into the grooves 460-463 of the sealing block 450. The sealing block 450 can then be inserted into one of the apertures or through holes 470-472 in the sealing region “S” of the front housing frame 100.

The cable boots 430-433, sealing block 450, and grooves 460-463 in the sealing block 450 are depicted as examples in FIGS. 5A and 5B. In other cases, the shape, size, proportion, and other characteristics of the cable boots 430-433, the sealing block 450, or both can vary as compared to that shown. For example, the sealing block 450 can be smaller or larger in the length “L” dimension shown in FIGS. 5A and 5B. The cable boots 430-433, the grooves 460-463, or both can be wider or more narrow in other examples.

The cable boots 430-433 are shorter in the length dimension “L” than the grooves 460-463 in the examples depicted in FIGS. 5A and 5B. In the example shown, the cable boots 430-433 are positioned at one side of the grooves 460-463, particularly towards the side of the grooves 460-463 closest to the plugs 410-413, and part of the grooves 460-463 are unoccupied (see FIG. 5A). However, in other cases, the cable boots 430-433 can be positioned at the opposite side of the grooves 460-463, particularly the side closest to the optical receptacles 40 and the back of the feedthrough device 10. In still other cases, the cable boots 430-433 can be positioned in the middle of the grooves 460-463. The cable boots 430-433 can also be formed to be longer than that shown, formed to have the same length as the grooves 460-463, or formed to be longer than the grooves 460-463 in some cases.

FIG. 6A illustrates a back perspective view of the front housing frame 100, and FIG. 6B illustrates a front view of the front housing frame 100. FIG. 6A depicts the front housing frame 100 with sealing blocks positioned within apertures in the sealing region “S,” and FIG. 6A depicts the front housing frame 100 without the sealing blocks. The optical signal modules and fiber optic cable bundles are omitted from view in FIGS. 6A and 6B for simplicity.

Referring between FIGS. 6A and 6B, the sealing blocks 450-452 are positioned within the apertures or through holes 470-472, respectively, and other sealing blocks are positioned within other through holes of the front housing frame 100. More particularly, to assemble the feedthrough device 10, the cable boots 430-433 (see FIG. 5B) can be inserted respectively into the grooves 460-463 of the sealing block 450. The sealing block 450 can then be inserted into one of the apertures or through holes 470-472 of the front housing frame 100. The sealing blocks 450-452, among others, can be formed from a metal, such as aluminum, or another suitable metal or metal alloy. Metals have a relatively low CTE and can be preferable for maintaining seals during temperature cycling. In other examples, the sealing blocks 450-452 can be formed from an elastic and sealing material, such as a TPR material. The sealing blocks 450-452 can also be formed from other suitable materials, however, such as TPEs, plastics, such as LCP, polyethylene PE, PTFE, fluoropolymer, or other insulating material(s). The sealing blocks 450-452 can also be formed from more elastic and compressible material(s) in some cases, including rubber, foam, cork, and related materials. The sealing blocks 450-452 can be sized to seat snugly within the through holes 470-472 with a friction or interference fit between them, forming a seal or near seal between them in one example. It is not necessary that the sealing blocks 450-452 form a tight interference fit with the through holes 470-472 in all cases, however, and the sealing blocks 450-452 can be further secured and sealed within the through holes 470-472 using an adhesive, sealant, or other means as needed and described below.

In the example shown, the sealing blocks 450-452 are positioned within the through holes 470-472 such that a region of free space “Sp” is free or open in each of the through holes 470-472. The region of free space “Sp” is towards the rear or back of the front housing frame 100. This free space “Sp” in each through hole of the front housing frame 100 can be filled with an additional sealing means, such as an epoxy, silicone, foam, rubber, or other sealing means or filler. A sealant 480 is depicted in FIG. 6A, for example, within the free space “Sp” of the hole 462, and the other spaces can also be filled with a similar sealant. The sealant 480 can be embodied as an epoxy, silicone, foam, rubber, or other sealing means or filler. In other cases, the sealing blocks 450-452 can be positioned at other locations within the through holes 470-472. In some cases, a sealant similar to the sealant 480 can be applied to the opposite side of the sealing blocks 450-452, among others, from within the interior space 150 of the front housing frame 100. In some cases, sealant can be applied both on the back and the front of the sealing region “S.”

When the feedthrough device 10 is assembled, the optical signal module 400 shown in FIGS. 5A and 5B extends through the through hole 470 in the sealing wall region of the front housing frame 100. Particularly, the fiber optic cable bundles 420-423 extend through the grooves 460-463 in the sealing block 450, with the cable boots 430-433 positioned within the grooves 460-463, as shown in FIG. 5A. The sealing block 450 is positioned in the through hole 470. The sealing block 450 substantially occupies and fills open space within the through hole 470 in the sealing region “S” of the front housing frame 100. An additional sealing means, such as the sealant 480, can be used to seal the free space “Sp”. The sealant 480 can also fill in and occupy any part of the grooves 460-463 that are unoccupied by the cable boots 430-433 (see FIG. 5A).

FIG. 6B also illustrates an inner flange rim surface 180 within the front housing frame 100. The front support wall 130 shown in FIG. 2B can be secured in place, within the front opening of the front housing frame 100, against the inner flange rim surface 180 using the fasteners 132 and 134. The fasteners 132 and 134 can extend through apertures in the front support wall 130 and be threaded into the threaded apertures 182 and 184 of the front housing frame 100, to hold and secure the front support wall 130 in place.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A feedthrough device, comprising:
housing assembly, the housing assembly comprising a front housing frame and a rear housing unit;
an optical signal module, the optical signal module comprising a fiber optic cable bundle and a cable boot positioned along a length of the fiber optical cable bundle; and
a sealing block comprising a groove, wherein:
the front housing frame comprises a through hole;
the cable boot is positioned in the groove of the sealing block; and
the sealing block is positioned within the through hole of the front housing frame with the fiber optic cable bundle extending through the sealing block.

2. The feedthrough device according to claim 1, wherein the front housing frame comprises an open flange end and a sealing wall region.

3. The feedthrough device according to claim 2, wherein:
the through hole is positioned through the sealing wall region of the front housing frame;
the sealing block is positioned in the through hole with a region of free space at one side of the through hole at a back side of the front housing frame; and
the feedthrough device further comprises a sealant positioned within the free space in the through hole.

4. The feedthrough device according to claim 3, wherein:
the cable boot is positioned in the groove of the sealing block with a region of the groove being unoccupied by the cable boot; and
the sealant is also positioned within the region of the groove that is unoccupied by the cable boot.

5. The feedthrough device according to claim 1, wherein:
the optical signal module comprises a plurality of fiber optic cable bundles and a cable boot positioned along a length of each fiber optic cable bundle among the plurality of fiber optic cable bundles;
the sealing block comprises a plurality of grooves; and
each cable boot is positioned in one of the plurality of grooves.

6. The feedthrough device according to claim 1, further comprising:
a front support wall secured within an opening in the front housing frame;
a rear support wall secured at an end of the rear housing unit;
a connection adapter supported in the front support wall; and
an optical receptacle supported in the rear support wall, wherein the fiber optic cable bundle extends from the connection adapter supported in the front support wall, through the sealing block and a sealing wall region of the front housing frame, and to the optical receptacle supported in the rear support wall.

7. The feedthrough device according to claim 1, further comprising:
a plurality of connection adapters supported in a front support wall; and
a plurality of optical receptacles supported in a rear support wall, wherein:
the optical signal module comprises a plurality of fiber optic cable bundles; and
each fiber optic cable bundle among the plurality of fiber optic cable bundles extends from a respective connection adapter supported in the front support wall, through a sealing wall region of the front housing frame, and to a respective optical receptacle supported in the rear support wall.

8. The feedthrough device according to claim 7, further comprising an optical reshuffling bridge unit positioned within the rear housing unit and between the plurality of fiber optic cable bundles.

9. The feedthrough device according to claim 1, further comprising a housing sleeve positioned around the rear housing unit and configured to slide between positions.

10. A feedthrough device, comprising:
housing assembly;
a fiber optic cable bundle and a cable boot positioned along a length of the fiber optical cable bundle; and
a sealing block comprising a groove, wherein:
the housing assembly comprises a through hole in a sealing wall region;
the cable boot is positioned in the groove of the sealing block; and
the sealing block is positioned within the through hole with the fiber optic cable bundle extending through the sealing block.

11. The feedthrough device according to claim 10, wherein:
the through hole is positioned through a sealing wall region of the housing assembly;
the sealing block is positioned in the through hole with a region of free space at one side of the through hole; and
the feedthrough device further comprises a sealant positioned within the free space in the through hole.

12. The feedthrough device according to claim 11, wherein:
the cable boot is positioned in the groove of the sealing block with a region of the groove being unoccupied by the cable boot; and
the sealant is also positioned within the region of the groove that is unoccupied by the cable boot.

13. The feedthrough device according to claim 10, wherein:
the fiber optic cable bundle comprises a plurality of fiber optic cable bundles and a cable boot positioned along a length of each fiber optic cable bundle among the plurality of fiber optic cable bundles;
the sealing block comprises a plurality of grooves; and
each cable boot is positioned in one of the plurality of grooves.

14. A feedthrough device, comprising:
housing assembly;
a fiber optic cable and a cable boot positioned along a length of the fiber optical cable; and
a sealing block comprising a groove, wherein:
the cable boot is positioned in the groove of the sealing block; and
the sealing block and cable boot are positioned within a through hole in a sealing wall region of the housing assembly.

15. The feedthrough device according to claim 14, wherein:
the sealing block and cable boot are positioned in the through hole with a region of free space at one side of the through hole; and
the feedthrough device further comprises a sealant positioned within the free space in the through hole.

16. The feedthrough device according to claim 15, wherein:
the cable boot is positioned in the groove of the sealing block with a region of the groove being unoccupied by the cable boot; and
the sealant is also positioned within the region of the groove that is unoccupied by the cable boot.

17. The feedthrough device according to claim 14, wherein:
the housing assembly comprises a front housing frame and a rear housing unit;
the front housing frame comprises the sealing wall region and the through hole in the sealing wall region; and
the sealing block and cable boot are positioned within the through hole in the sealing wall region of the front housing frame.

18. The feedthrough device according to claim 14, wherein:
the housing assembly comprises a front housing frame and a rear housing unit;
the rear housing unit comprises an upper rear housing unit and a lower rear housing unit; and
the upper rear housing unit and the lower rear housing unit comprise hermaphroditic housing units.

19. The feedthrough device according to claim 14, wherein:
the housing assembly comprises a front housing frame, a rear housing unit, and a housing sleeve positioned around the rear housing unit;
the housing sleeve comprises an elongated aperture formed in a side of the housing sleeve; and
the feedthrough device further comprises a threaded knob that extends through the elongated aperture and is threaded into a threaded aperture on a side of the rear housing unit.

20. The feedthrough device according to claim 19, wherein:
the elongated aperture comprises an eyelet centrally positioned along the elongated aperture;
the eyelet of the elongated aperture is larger than a remainder of the elongated aperture;
the threaded knob comprises a knob head, a shaft, and a threaded portion of the shaft;
the threaded portion of the shaft fits through the eyelet of the elongated aperture with a clearance;
a mechanical interference exists between the threaded portion of the shaft and the remainder of the elongated aperture; and
a mechanical clearance exists between the threaded portion of the shaft and the remainder of the elongated aperture.
